(19) United States
(12) Patent Application Publication
(10) Pub. No.: US 2009/0119321 A1
(43) Pub. Date: May 7, 2009

(54) METHODS AND COMPUTER PROGRAM PRODUCTS FOR IMPLEMENTING LOW-COST POINTER COMPRESSION AND DECOMPRESSION

(75) Inventor: Marcel Mitran, Markham (CA)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/934,111

(22) Filed: Nov. 2, 2007

(51) Int. Cl. G06F 17/30

(52) U.S. Cl. 707/101; 707/E17.002

(57) ABSTRACT

Prior art attempts to provide 32-bit addressing within a 64-bit computing environment lead to other complications. Hardware solutions result in more complicated hardware which, in turn, increases costs and may reduce the functionality of 64-bit computing and significant changes to commercially available 64-bit processors. Alternatively, previous software solutions are computationally expensive, requiring add and subtract routines convert between 32-bit addresses and 64-bit addresses. An additional problem, specific to IBM™ zSeries hardware, is that the only way to provide a heap size larger than 2 GB, even if less than 4 GB, is to employ the 64-bit addressing in combination with a computationally expensive software patch to emulate 32-bit addressing. By contrast, provided by aspects of the present invention there are systems, methods and computer program products for implementing low-cost pointer compression and decompression. In accordance with more specific aspects of the invention, the systems, methods and computer program products for implementing low-cost point compression and decompression can be specifically adapted to compress 64-bit pointers to 32-bit pointers, and conversely convert 32-bit pointers to 64-bit pointers.

### FIELD OF THE INVENTION

The invention relates to data addressing, and in particular to methods and computer program products for implementing low-cost pointer compression and decompression.

### BACKGROUND OF THE INVENTION

Computer processors with 64-bit architectures use 64-bit addressing in which memory locations can be uniquely identified by a 64-bit value. For many applications, each 64-bit value, representing a memory location (i.e. a pointer to the memory location), is typically stored within a pointer stack. The pointer stack is a portion of memory storing memory addresses of corresponding data in another location in the memory. That is, the pointer stack is a portion of memory allocated to store pointers that address other portions of the 64-bit addressable memory. The other portions of the 64-bit addressable memory used by a particular application is often collectively referred to as an “application heap”, or for brevity simply a “heap”. In a 64-bit computing environment the pointers are also 64-bits long. In practical terms, 64-bit addressing is achieved with 64-bit integer registers or general purpose registers in RISC terms. The 64-bit registers allow 64-bit pointers from the pointer stack to fit into a single register. The advantage of using 64-bit addressing is that large amounts of memory can be addressed. For example, while 32-bit processors are limited to addressing (2³²) 4 GB of memory, a 64-bit processor can address up to (2⁶⁴) 18 billion GB of memory. The practical limit of addressable memory is dependent on the specific hardware architecture and operating system employed. For example, in Linux based-operating systems, the addressable memory is limited to (2⁴²) 4096 GB due to the current design of internal Linux kernal data structures.

While there are also other advantages to 64-bit addressing, there are also drawbacks that affect the actual performance of 64-bit computing as compared to 32-bit computing. The major drawback of 64-bit computing comes from the fact that 64-bit binary addresses are larger than 32-bit binary addresses, even when only 4 GB (or less) of memory is required for a given application. As a consequence, with a larger final machine code size and a given size of cache and Translation Lookaside Buffer (TLB), the chances of both cache and TLB misses increase, which in turn, may decrease the performance and negate the benefits of using 64-bit computing. Accordingly, 32-bit addressing within a 64-bit computing environment was seen as an option for realizing the benefits of 64-bit computing while limiting the drawbacks.

However, prior art attempts to provide 32-bit addressing within a 64-bit computing environment lead to other complications. Hardware solutions typically include integrating 32-bit processing directly into the hardware architecture as a separate and parallel sub-processor. However, this leads to more complicated hardware which, in turn, increases costs and may reduce the functionality of 64-bit computing since the 32-bit sub-processor is not completely functionally integrated within the main 64-bit processor. Moreover, it requires significant changes to commercially available 64-bit processors. Alternatively, previous software solutions are computationally expensive. Specifically, the previous software solutions require the maintenance of numerous heap-base values that each define a respective virtual 32-bit region within a 64-bit addressable heap. And in order to store and use the pointers to access the heap, add and subtract routines are needed to convert between 32-bit addresses and 64-bit addresses.

An additional problem, specific to IBM™ zSeries hardware, is the limitation of the types of addressing modes supported. IBM™ zSeries hardware allows for three addressing modes, including 24-bit, 31-bit and 64-bit addressing. Most other enterprise systems allow for 32-bit and 64-bit addressing as described above. The 31-bit addressing mode is limited to a maximum heap size of (2³¹) 2 GB. The 2 GB constraint on the maximum heap size is unpopular with some users. The only way to provide for a larger heap size, even if less than 4 GB, is to employ the 64-bit addressing in combination with a computationally expensive software patch to emulate 32-bit addressing.

### SUMMARY OF THE INVENTION

According to an aspect of an embodiment of the invention, there is provided a computer-implemented method for a computer-implemented method for pointer compression in which a first pointer is converted to a second pointer having fewer bits than the first pointer, the method comprising: loading the first pointer into a first register, wherein the first register is long enough to include all of the bits included in the first pointer; and masking off at least one of the most significant bits within the first register to produce the second pointer, wherein masking off a particular bit in the first register results in that bit having a zero value and the precise number of bits that are masked is equivalent to the different in the bit length between the first and second pointer.

According to some aspects of the invention, the length of the first pointer is 64-bits and the length of the second pointer is 32-bits.

According to some aspects of the invention, the method further comprises storing the second pointer in a pointer stack.

According to an aspect of an embodiment of the invention, there is provided a computer-implemented method for pointer decompression in which a first pointer is created from a second pointer having fewer bits than the first pointer, the method comprising: loading the second pointer into a first register, wherein the first register is long enough to include all of the bits included in the first pointer; and zero extending the contents of the first register such that the value of the second pointer is preserved in the least-significant bits of the first register and the bit values of the most significant bits in the first register are given a zero value.

According to another aspect of an embodiment of the invention, there is provided a computer program product implementing a method for pointer compression in which a first pointer is converted to a second pointer having fewer bits than the first pointer, the computer program product having computer code instructions for: loading the first pointer into a first register, wherein the first register is long enough to include all of the bits included in the first pointer; and masking off at least one of the most significant bits within the first register to produce the second pointer, wherein masking off a particular bit in the first register results in that bit having a zero value and the precise number of bits that are masked is equivalent to the different in the bit length between the first and second pointer.

According to another aspect of an embodiment of the invention, there is provided a computer program product implementing a method for pointer decompression in which a first pointer is created from a second pointer having fewer bits than the first pointer, the computer program product having computer code instructions for: loading the second pointer into a first register, wherein the first register is long enough to include all of the bits included in the first pointer; and zero extending the contents of the first register such that the value of the second pointer is preserved in the least-significant bits of the first register and the bit values of the most significant bits in the first register are given a zero value.

Other aspects and features of the present invention will become apparent to those ordinarily skilled in the art, upon review of the following description of the specific embodiments of the invention.

### BRIEF DESCRIPTION OF THE DRAWINGS

For a better understanding of the present invention, and to show more clearly how it may be carried into effect, reference will now be made, by way of example, to the accompanying drawings, which illustrate aspects of embodiments of the present invention and in which:

FIG. 1 is a schematic diagram of an example computer hardware environment suitable for use with aspects of the invention;

FIG. 2 is a flow chart illustrating general method steps for compressing and storing a 32-bit pointer in accordance with aspects of the prior art;

FIG. 3 is a flow chart illustrating general method steps for decompressing a 32-bit pointer and retrieving data in accordance with aspects of the prior art;

FIG. 4 is a flow chart illustrating general method steps for compressing and storing a 32-bit pointer in accordance with the aspects of the invention;

FIG. 5 is a flow chart illustrating general method steps for decompressing a 32-bit pointer and retrieving data in accordance with aspects of the invention; and

FIG. 6 is a flow chart illustrating general method steps of initiating low-cost pointer compression/decompression in accordance with aspects of the invention.

### DETAILED DESCRIPTION OF THE INVENTION

Prior art attempts to provide 32-bit addressing within a 64-bit computing environment lead to other complications. Hardware solutions result in more complicated hardware which, in turn, increases costs and may reduce the functionality of 64-bit computing and may require significant changes to commercially available 64-bit processors. Alternatively, previous software solutions are computationally expensive. They require the maintenance of numerous heap-base values that each define a respective virtual 32-bit region within the 64-bit addressable heap. And in order to store and use the pointers to access the heap, add and subtract routines are needed to convert between 32-bit addresses (for storage) and 64-bit addresses (for use by the 64-bit processor).

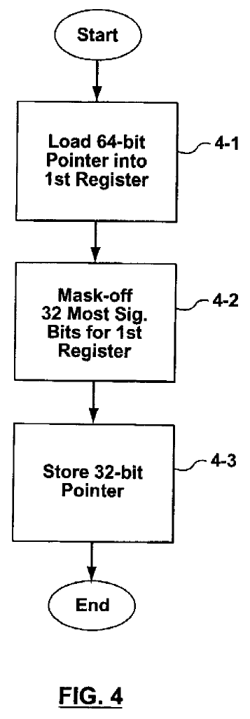

By contrast, provided by aspects of the present invention there are methods and computer program products for implementing low-cost pointer compression and decompression. In accordance with more specific aspects of the invention, the systems, methods and computer program products for implementing low-cost point compression and decompression can be specifically adapted to compress 64-bit pointers to 32-bit pointers, and conversely convert 32-bit pointers to 64-bit pointers. Specific aspects of the invention are described below with reference to FIGS. 4 to 6. FIGS. 4 to 6 rely on a running example used to describe aspects of the invention with reference to 64-bit pointers and 32-bits pointers for illustrative purposes only. Additionally and/or alternatively, those skilled in the art will appreciate that in accordance with aspects of the invention systems, methods and computer program products can be specifically adapted to convert between a first arbitrarily large pointer and a second arbitrarily small pointer after reviewing the present disclosure.

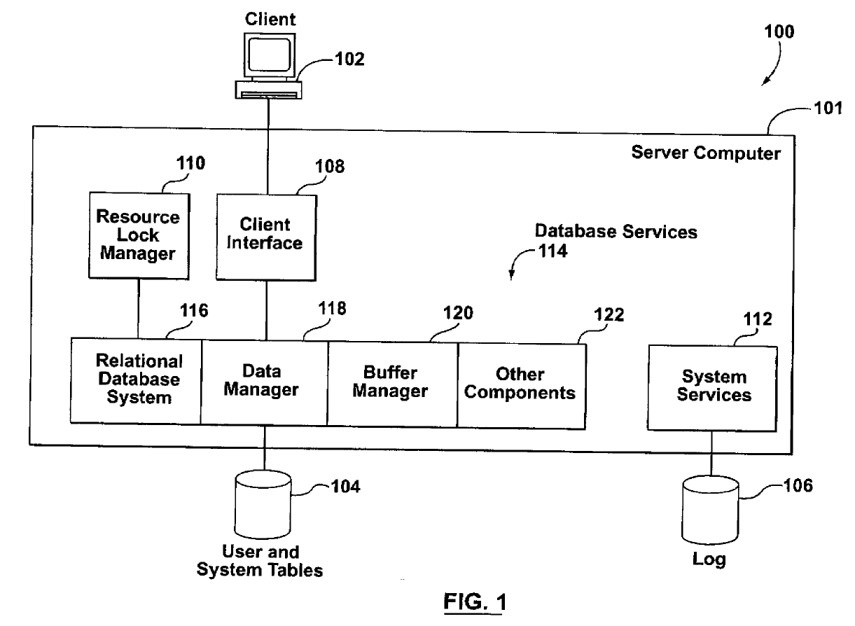

Referring to FIG. 1, shown is a simplified schematic drawing of an example computer hardware environment, generally indicated by 100, suitable for use with aspects of the invention. The computer hardware environment 100 includes a server computer 101, a client computer 102, user and system tables 104 and a system log 106. Although only one client computer 102 is illustrated, any number of client network nodes/computers may be provided in alternative embodiments.

The server computer 101 includes a Relational Database Management System (RDBMS) and a client interface 108. The client computer 102 interfaces to the RDBMS via the client interface 108. In operation the server computer 101 executes RDBMS that manages the user and system tables 104 and system log 106. The RDBMS includes a number of modules including a Resource Lock Manager (RLM) 110, a Systems Services Module 112, and the Database Services Module 114.

A RDBMS is generally designed to treat data as a shared resource, thereby permitting a number of users to access the data simultaneously. Accordingly, concurrency control is desirable to isolate users and maintain data integrity. To that end, the RLM 110 is provided to handle locking services for isolating users and maintaining data integrity.

The Systems Services Module 112 controls the overall RDBMS execution environment, including managing the system log 106, gathering statistics, handling startup and shutdown, and providing management support.

The Databases Service Module 114 includes several sub-modules including a Relational Database System (RDS) 116, Data Manager 118, Buffer Manager 120, and other components 122 such as an SQL compiler/interpreter. These sub-modules support the function of the SQL language (e.g. query definition, access control, retrieval and update, etc.).

In some very specific embodiments of the invention, a Relational Database Management System (RDBMS) comprises the DataBase 2 (DB2™) Universial DataBase (UDB™) product offered by IBM™ Corporation. However, those skilled in the art will appreciate that the present invention may be applied to any RDBMS and that the computer hardware environment 100 depicted in FIG. 1 has been provided as merely an example.

Generally, the RDBMS includes logic and/or data that is embodied in or retrievable from a device, medium, or carrier (e.g. a fixed or removable data storage device, a remote device coupled to the computer by a data communications device, etc.). Moreover, this logic and/or data, when read, executed, and/or interpreted by the server computer 101, causes the server computer 101 to perform method steps provided in accordance with aspects of the invention and described in detailed below.

Aspects of the invention may be embodied in a number of forms. For example, various aspects of the invention can be embodied in a suitable combination of hardware, software and firmware. In particular, some embodiments include, without limitation, entirely hardware, entirely software, entirely firmware or some suitable combination of hardware, software and firmware. In a preferred embodiment, the invention is implemented in software, which includes but is not limited to firmware, resident software, microcode, etc.

Additionally and/or alternatively, aspects of the invention can be embodied in the form of a computer program product that is accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by, or in connection with, the instruction execution system, apparatus, or device.

A computer-readable medium can be an electronic, magnetic, optical, electromagnetic, infrared, or semiconductor system (or apparatus or device) or a propagation medium. Examples of a computer-readable medium include a semiconductor and/or solid-state memory, magnetic tape, a removable computer diskette, a random access memory (RAM), a read-only memory (ROM), a rigid magnetic disk and an optical disk. Current examples of optical disks include, without limitation, compact disk—read only memory (CD-ROM), compact disk—read/write (CD-R/W) and DVD.

In accordance with aspects of the invention, a data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (i.e. I/O devices)—including but not limited to keyboards, displays, pointing devices, etc.—can be coupled to the system either directly or through intervening I/O controllers.

Network adapters may also be coupled to the system to enable communication between multiple data processing systems, remote printers, or storage devices through intervening private or public networks. Modems, cable modems and Ethernet cards are just a few of the currently available types of network adapters.

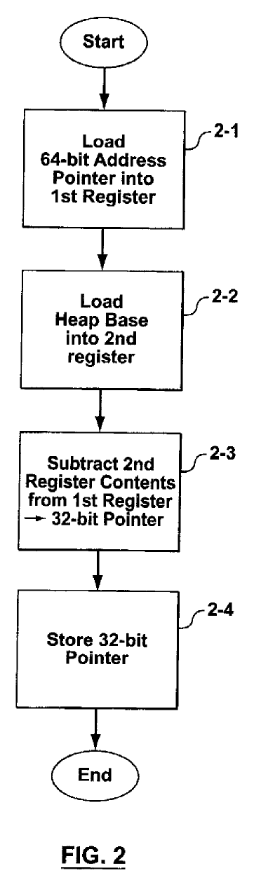

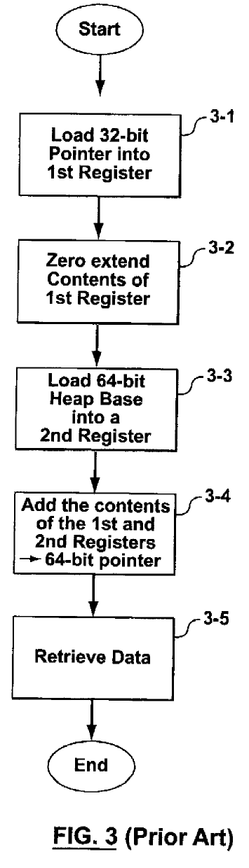

FIGS. 2 and 3 are provided to help illustrate the relative complexity between prior art solutions for compressing and decompressing pointers. Referring first to FIG. 2, shown is a flow chart illustrating general method steps for compressing and storing a 32-bit pointer in accordance with aspects of the prior art. Starting at step 2-1, the prior art pointer compression method includes loading a full 64-bit address pointer into a first register provided by the hardware (typically within a processor). Step 2-2 includes loading a 64-bit heap base into a second register provided by the hardware (also typically within the processor). Step 2-3 includes subtracting the contents of the second register from the first register to produce a 32-bit pointer. That is, the resulting 32-bit pointer is the difference between the respective contents of the first and second registers. Step 2-4 includes storing the 32-bit pointer in the pointer stack. Those skilled in the art will appreciate that each of the steps 2-1, 2-2, 2-3 and 2-4 requires a distinct machine code command (i.e. operation) carried out by the processor that takes a measurable amount of time and processor capacity.

Turning to FIG. 3, shown is a flow chart illustrating general method steps for decompressing a 32-bit pointer and retrieving data in accordance with aspects of the prior art. Starting at step 3-1, the prior pointer decompression method includes loading a 32-bit pointer into the first register. Step 3-2 includes zero extending the contents of the first register so that the thirty-two most significant bits of the sixty-four bits of the first register do not contain invalid values that could introduce errors into the decompression process. Step 3-3 includes loading a 64-bit heap base into the second register. Step 3-4 includes adding the contents of the first and second registers to produce the 64-bit pointer. That is, the 64-bit pointer is the sum of the contents of the first and second registers. Step 3-5 includes accessing or retrieving data addressed by the 64-bit pointer. Those skilled in the art will appreciate that each of the steps 3-1, 3-2, 3-3, 3-4 and 3-5 requires a distinct machine code command (i.e. operation) carried out by the processor that takes a measurable amount of time and processor capacity.

FIG. 4 is a flow chart illustrating general method steps for compressing and storing a 32-bit pointer in accordance with the aspects of the invention. Starting at step 4-1, the pointer compression method according to aspects of the invention includes loading the 64-bit pointer into the first register. Step 4-2 includes masking off thirty-two of most significant bits of the 64-bit pointer. Those skilled in the art will appreciate that the step of masking off the thirty-two most significant bits is often a free operation in most processors, since masking simply involved ignoring the bits to be masked. In processors where the masking operation is not completely free, the masking operation still only requires less processing capacity of the processor compared to an add or subtract operation, even without considering the step of loading a second register. Step 4-3 includes storing the 32-bit pointer. In comparison to the prior art method described above with reference to FIG. 2, the method illustrated in FIG. 4 saves at least one processing step and possibly as many as two processing steps per memory access, depending on the processor employed. This savings adds up during the run time of an application requiring numerous memory access operations, and may result in better performance compared to the prior art method described above. Moreover, this savings may also offset drawbacks from using the 64-bit processor with 64-bit addressing or from switching to a 32-bit addressing mode within a 64-bit computing environment.

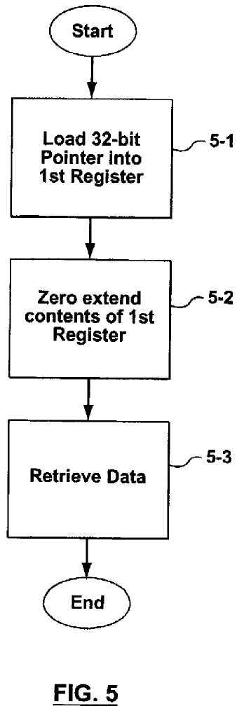

FIG. 5 is a flow chart illustrating general method steps for decompressing a 32-bit pointer and retrieving data in accordance with aspects of the invention. Starting at step 5-1, the pointer decompression method according to aspects of the invention includes loading the 32-bit pointer into the first register. Step 5-2 includes zero extending the contents of the first register. That is, the thirty-two bits most significant bits of the first register are set to zero since only the thirty-two least significant bits may have valid non-zero values. And step 5-3 includes retrieving the date. In comparison to the prior art method described above with reference to FIG. 3, the method illustrated in FIG. 5 saves at least two processing steps and possibly as many as three processing steps per memory access, depending on the processor employed. This savings adds up during the run time of an application requiring numerous memory access operations, and may result in better performance compared to the prior art method described above. Moreover, this savings may also offset drawbacks from using the 64-bit processor with 64-bit addressing or from switching to a 32-bit addressing mode within a 64-bit computing environment.

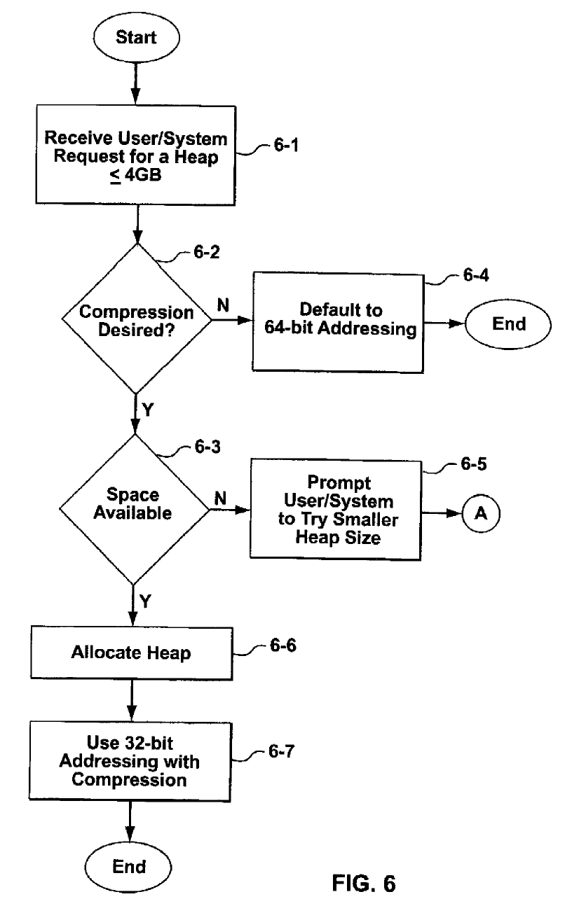

Turning to FIG. 6, shown is a flow chart illustrating general method steps of initiating low-cost pointer compression/decompression in accordance with aspects of the invention. This method according to aspects of the invention can be used to provide users or a system the option of selecting the use of pointer compression and decompression in accordance with aspects of the invention. Starting at step 6-1, the method begins with receiving a user (or system) request for a heap that is less than or equal to 4 GB. The request may be accompanied by an indication that pointer compression is also desired. For example, if the request is from a user using command line instructions, the instruction may include the addition of a flag that indicates that pointer compression and decompression is desired.

Step 6-2 of the method includes determining whether or not pointer compression and decompression is desired. If pointer compression and decompression is not desired (no path, step 6-2), the method proceeds to step 6-4 that includes defaulting to 64-bit addressing. On the other hand, if pointer compression and decompression is desired (yes path, step 6-2) the method proceeds to step 6-3. Step 6-3 includes determining whether or not space is available within the memory for the requested amount of memory space needed for the heap. If the space is not available (no path, step 6-3), the method proceeds to step 6-5 that includes prompting the user (or system) to try a smaller heap size. Thereafter, the method loops back to step 6-1. On the other hand, if the space is available (yes path, step 6-3), the method proceeds to step 6-6 which includes allocating the requested amount of memory for the heap. Thereafter, the method proceeds to step 6-7 which includes using 32-bit addressing in combination with pointer compression and decompression.

While the above description provides example embodiments, it will be appreciated that the present invention is susceptible to modification and change without departing from the fair meaning and scope of the accompanying claims. Accordingly, what has been described is merely illustrative of the application of aspects of embodiments of the invention and numerous modifications and variations of the present invention are possible in light of the above disclosure.

We claim:

1. A computer-implemented method for pointer compression in which a first pointer is converted to a second pointer having fewer bits than the first pointer, the method comprising:
loading the first pointer into a first register, wherein the first register is long enough to include all of the bits included in the first pointer; and
masking off at least one of the most significant bits within the first register to produce the second pointer, wherein masking off a particular bit in the first register results in that bit having a zero value and the precise number of bits that are masked is equivalent to the different in the bit length between the first and second pointer.

2. A method according claim 1, wherein the length of the first pointer is 64-bits and the length of the second pointer is 32-bits.

3. A method according to claim 1, further comprising storing the second pointer in a pointer stack.

4. A computer-implemented method for pointer decompression in which a first pointer is created from a second pointer having fewer bits than the first pointer, the method comprising:
loading the second pointer into a first register, wherein the first register is long enough to include all of the bits included in the first pointer; and
zero extending the contents of the first register such that the value of the second pointer is preserved in the least-significant bits of the first register and the bit values of the most significant bits in the first register are given a zero value.

5. A method according claim 4, wherein the length of the first pointer is 64-bits and the length of the second pointer is 32-bits.

6. A method according to claim 1, further comprising retrieving data stored in a memory location addressed by the first pointer.

7. A computer program product implementing a method for pointer compression in which a first pointer is converted to a second pointer having fewer bits than the first pointer, the computer program product having computer code instructions for:
loading the first pointer into a first register, wherein the first register is long enough to include all of the bits included in the first pointer; and
masking off at least one of the most significant bits within the first register to produce the second pointer, wherein masking off a particular bit in the first register results in that bit having a zero value and the precise number of bits that are masked is equivalent to the different in the bit length between the first and second pointer.

8. A computer program product according to claim 7, wherein the length of the first pointer is 64-bits and the length of the second pointer is 32-bits.

9. A computer program product according to claim 8, further comprising computer program code instructions for storing the second pointer in a pointer stack.

10. A computer program product implementing a method for pointer decompression in which a first pointer is created from a second pointer having fewer bits than the first pointer, the computer program product having computer code instructions for:
loading the second pointer into a first register, wherein the first register is long enough to include all of the bits included in the first pointer; and
zero extending the contents of the first register such that the value of the second pointer is preserved in the least-significant bits of the first register and the bit values of the most significant bits in the first register are given a zero value.

11. A computer program product according claim 10, wherein the length of the first pointer is 64-bits and the length of the second pointer is 32-bits.

12. A computer program product according to claim 11, further comprising computer program code instructions for retrieving data stored in a memory location addressed by the first pointer.
